(19) United States
(12) Patent Application Publication
(10) Pub. No.: US 2004/0185279 A1
(43) Pub. Date: Sep. 23, 2004

(54) Method and apparatus for improved fastening hardware

(75) Inventor: Steven T. Fink, Mesa, AZ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 10/764,456

(22) Filed: Jan. 27, 2004

Related U.S. Application Data
(60) Provisional application No. 60/442,591, filed on Jan. 27, 2003.

(51) Int. Cl. B32B 15/04

(52) U.S. Cl. 428/472.2; 411/378

(57) ABSTRACT

This invention relates to an improved component for a plasma processing system, and more particularly, to fasteners for internal chamber parts in a plasma processing chamber. Further, this invention relates to a method of manufacturing such a fastener.

### CROSS-REFERENCE TO RELATED APPLICATIONS

This application claims priority to and is related to U.S. Provisional Application Serial No. 60/442,591, filed on Jan. 27, 2003. The contents of this application are incorporated herein by reference.

### BACKGROUND OF THE INVENTION

1. Field of the Invention

This invention relates to an improved component for a plasma processing system, and more particularly, to hardware fasteners for internal chamber parts in a plasma processing chamber.

2. Discussion of the Background

The fabrication of integrated circuits in the semiconductor industry typically employs plasma to create and assist surface chemistry within a plasma reactor necessary to remove material from and deposit material to a substrate. In general, plasma is formed within the plasma reactor under vacuum conditions by heating electrons to energies sufficient to sustain ionizing collisions with a supplied process gas. Moreover, the heated electrons can have energy sufficient to sustain dissociative collisions and, therefore, a specific set of gasses under predetermined conditions (e.g. chamber pressure, gas flow rate, etc.) are chosen to produce a population of charged species and chemically reactive species suitable to the particular process being performed within the chamber, e.g. etching processes where materials are removed from the substrate or deposition where materials are added to the substrate.

Although the formation of a population of charged species (ions, etc.) and chemically reactive species is necessary for performing the function of the plasma processing system (i.e. material etch, material deposition, etc.) at the substrate surface, other component surfaces on the interior of the plasma processing chamber are exposed to the physically and chemically active plasma and, in time, can erode. The erosion of exposed components in the plasma system can lead to a gradual degradation of the plasma processing performance and ultimately to complete failure of the system.

### SUMMARY OF THE INVENTION

These and other problems are addressed by the present invention which provides an apparatus and method for attaching replaceable parts within a process chamber such that the need to clean the chamber is reduced.

A first aspect of the invention is a fastener with coated protected surfaces resistant to etching by a processing plasma.

A second aspect of the present invention is a method of fabricating plasma resistant fasteners such that the fasteners are machined in a single step.

A third aspect of the present invention is a method of fabricating plasma resistant fasteners such that the fasteners are machined in multiple steps.

### BRIEF DESCRIPTION OF THE DRAWINGS

The above-noted and other aspects of the present invention will become more apparent from a detailed description of preferred embodiments when read in conjunction with the drawings, wherein:

FIGS. 1A-1D are plan views of various types of fasteners illustrating exemplary recesses therein;

FIGS. 1E-1H are side views of the fasteners of FIGS. 1A-1D;

FIG. 2 is a cross-sectional view of a portion of one type of fastener showing a protective coating over a portion of the fastener;

FIG. 3 depicts a flow chart representing a method of fabricating a fastener according to one embodiment of the present invention;

FIG. 4 depicts a flow chart representing another method of fabricating a fastener according to the present invention wherein at least a portion of the fastener is anodized;

FIG. 5 depicts a flow chart representing another method of fabricating a fastener according to the present invention wherein at least a portion of the fastener is masked; and

FIG. 6 depicts a flow chart representing another method of fabricating a fastener according to the present invention in which multiple machining steps are used.

### DETAILED DESCRIPTION OF THE PREFERRED EMBODIMENTS

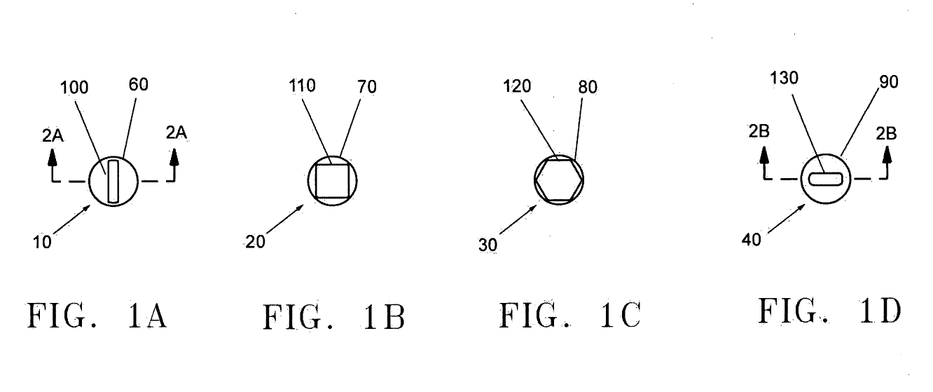

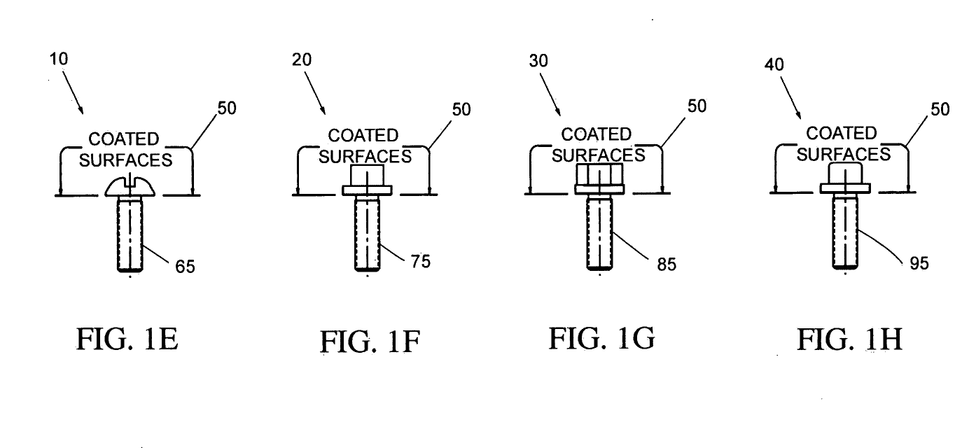

FIGS. 1A-1D and 1E-1H depict plan and side views, respectively, of improved fasteners 10, 20, 30, and 40 with a protective barrier 50. The fasteners can have several different types of fastener heads 60, 70, 80, and 90, respectively. The fasteners can have several different types of mating sections 65, 75, 85, and 95, respectively. Fastener 10 has an elongate female recess 100 along a diameter of the fastener head 60. Fastener 20 has a square male shape 110 in the center of fastener head 70. Fastener 30 has a hexagonal male shape 120 in the center of fastener head 80. Lastly, fastener 40 has an oblong male shape 130 in the center of fastener head 90. Alternately, male shapes can be substituted for female recesses, and female recesses can be substituted for male shapes. In other embodiments, geometrical or non-geometrical shapes can be used for female recesses and/or male shapes.

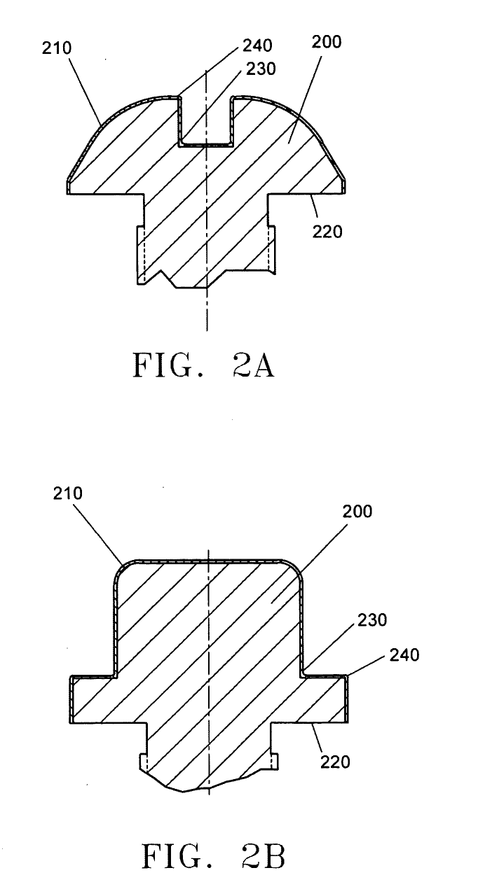

FIGS. 2A and 2B identify detailed cross-sectional views of typical fasteners 200. In the illustrated embodiments, a protective barrier coating 210 can be seen applied to the head portion 220 of the fastener 200 (e.g., any one of fasteners 10, 20, 30, and 40). The protective barrier coating 210 of the fastener 200 is applied to substantially all of the surfaces normally exposed to plasma processing.

The protective barrier can comprise a compound including an oxide of aluminum such as Al₂O₃. The protective barrier coating 210 can also comprise at least one of a III-column (column III of the periodic table) and a Lanthanon element. Further, the III-column element comprises at least one of Cerium, Dysprosium, and Europium. In another aspect of the present invention, the compound forming the protective barrier comprises at least one of Y₂O₃, Sc₂O₃, Sc₂F₃, La₂O₃, CeO₂, Eu₂O₃, or DyO₃.

The protective barrier coating 210 of fastener 200 comprises a specified thickness, wherein the specified thickness can be either constant across any specified surface or variable over any specified surface. For example a variable thickness can occur at an internal corner 230 or an external corner 240 of the fastener 200. Furthermore, the protective barrier formed on the fastener comprises a specific tolerance, wherein the specified tolerance can be specified as constant across any one surface and variable across any other surface. Preferably, the thickness of the protective barrier coating ranges from about 50 micron to about 500 micron, more preferably, the specified thickness of the protective barrier coating ranges from about 100 micron to about 200 micron; and most preferably, the specified thickness of the protective barrier coating comprises 200 micron. Preferably, the thickness tolerance comprises plus or minus 50 micron. Therefore, the achieved thickness ranges from 0 micron to 550 micron; more preferably the achieved thickness ranges from 150 micron to 250 micron.

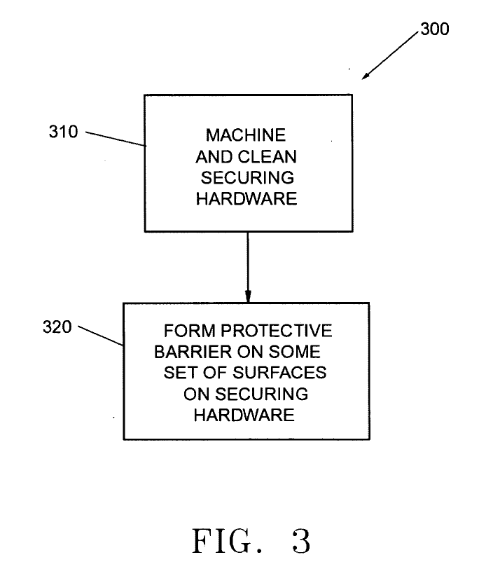

FIG. 3 represents a method of fabricating a fastener for a plasma processing system.

A flow diagram 300 begins with a machining operation step 310 that produces a fastener with a threaded shank portion and a head portion. The fastener can be machined according to specifications set forth on a mechanical drawing using conventional techniques for machining components that are well known to those skilled in the art of machining. The fastener can, for example, be fabricated from A6061 aluminum. After machining and cleaning of the fastener, surfaces of the fastener exposed to plasma processing are coated with a protective barrier in a coating step. Such a coating step can, for example, be a spray coating step.

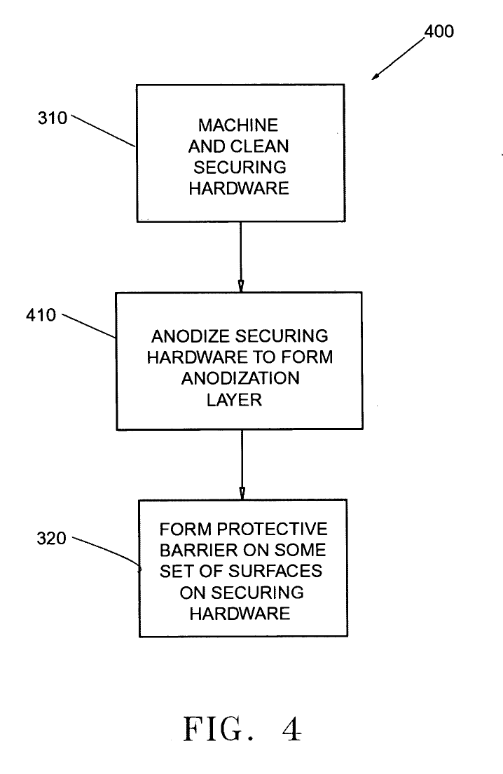

FIG. 4 depicts a flowchart 400 representing another method of fabricating a plasma resistant fastener according to the present invention. In the flow diagram 400, the fastener is again first machined and cleaned in a machining step 310. Next, the fastener goes through an anodization step 410 wherein the entire fastener is anodized to form a surface anodization layer. For example, when fabricating the fastener from aluminum, the surface layer comprises aluminum oxide (Al₂O₃). Methods of anodizing aluminum components are well known to those skilled in the art of surface anodization. After the anodization process, surfaces of the fastener exposed to plasma processing are coated with a protective barrier in the coating step 320 as described above.

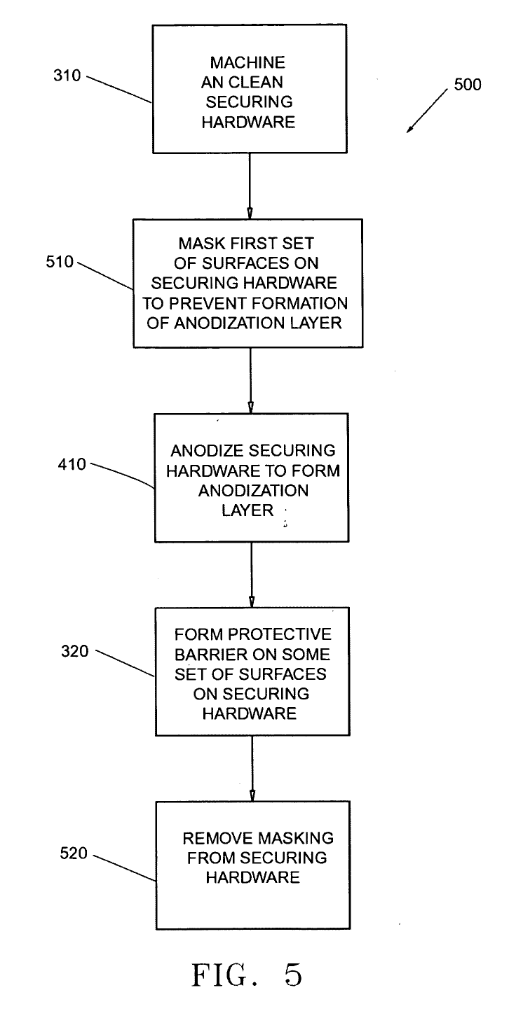

FIG. 5 presents another method of fabricating a plasma resistant fastener according to the present invention. In flow diagram 500, the fastener undergoes the step 310 of machining and cleaning using techniques described above. Next, in a masking step 510, a set of surfaces on the fastener is masked to prevent the formation of an anodization layer. The fastener then goes through an anodization step 410 such that the unmasked surfaces are anodized to form a surface anodization layer. After the anodization process, surfaces of the fastener exposed to a plasma proceSs that have been anodized are coated with a protective barrier in the coating step 320 as described above. Finally, in a masking removal step 520, the masking material is removed from the fastener. It should be noted that not all unmasked (or anodized) surfaces need to be later coated with a protective coating. Some surfaces, for example, may be designed to remain bare (i.e., free from the anodization layer) in order to achieve a better contact with a mating surface on another component.

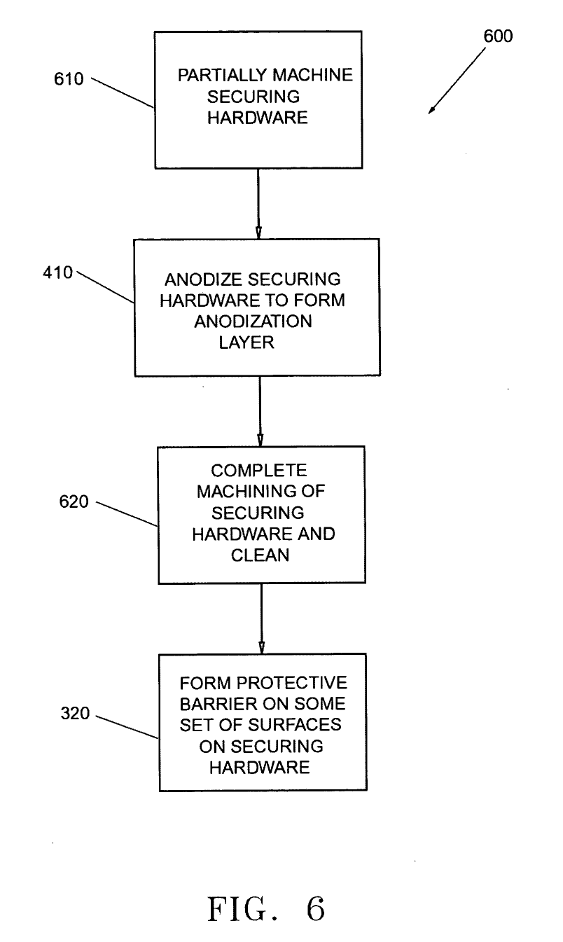

FIG. 6 presents another method of fabricating a plasma resistant fastener according to the present invention. In the flow diagram 600, the fastener is partially machined in a partial machining step 610. Next the partially completed fastener is anodized on all surfaces in an anodization step 410 as described above. Next the fastener is machined in a machining completion step 620 to provide the remaining features needed to complete the hardware. Finally, surfaces of the fastener that are exposed to plasma processing are coated in a coating step 320 as described above. In an alternate embodiment, steps 620 and 320 in FIG. 6 can be reversed.

1. A fastener for use in a plasma processing system comprising:
an enlarged head;
a mating section; and
a plasma resistant coating.

2. The fastener of claim 1 wherein the coating comprises Al₂O₃.

3. The fastener of claim 1 wherein the coating comprises Al₂O₃ and Y₂O₃.

4. The fastener of claim 1 wherein the coating comprises a compound containing at least one of a III-column element and a Lanthanon element.

5. The fastener of claim 4 wherein the III-column element comprises at least one of Cerium, Dysprosium, and Europium.

6. The fastener of claim 1 wherein the coating comprises at least one of Y₂O₃, Sc₂O₃, Sc₂F₃, La₂O₃, CeO₂, Eu₂O₃ or DyO₃.

7. The fastener of claim 1 wherein the enlarged head comprises a recess.

8. The fastener of claim 7 wherein said recess comprises an elongate female recess.

9. The fastener of claim 7 wherein said recess comprises a square recess.

10. The fastener of claim 7 wherein said recess comprises a hexagonal recess.

11. The fastener of claim 7 wherein said recess comprises an ovular recess.

12. The fastener of claim 1 wherein the enlarged head comprises a male shape.

13. The fastener of claim 12 wherein the male shape comprises a geometrical shape.

14. The fastener of claim 13 wherein the male shape comprises a hexagon.

15. The fastener of claim 12 wherein the male shape comprises a non-geometrical shape.

16. The fastener of claim 1 wherein the plasma resistant coating comprises a sprayed on coating.

17. The fastener of claim 16 wherein the enlarged head is resistant to plasma etching.

18. The fastener of claim 1 wherein a thickness of the coating is uniform along a first specified surface.

19. The fastener of claim 1 wherein the thickness of the coating is variable along a first specified surface.

20. A method of manufacturing a plasma resistant fastener comprising:
machining the fastener;
cleaning the fastener; and
forming a coating on the fastener sufficient to protect at least a portion of the fastener from plasma etching.

21. The method of claim 20 wherein the fastener is anodized after it is cleaned but before the coating is formed.

22. The method of claim 21 wherein a mask is applied to the fastener after the fastener is cleaned but before the fastener is anodized.

23. The method of claim 22 wherein the mask is removed from the fastener after the coating has been applied.

24. A method of making a fastener resistant to plasma etching comprising the steps of:
partially machining the fastener;
anodizing the fastener to form an anodization layer;
completing the partial machining of the fastener to a desired finish; and
forming a coating on said fastener sufficient to protect at least a portion of the fastener from plasma etching.
